(19) United States
(12) Patent Application Publication
(10) Pub. No.: US 2009/0175429 A1
(43) Pub. Date: Jul. 9, 2009

(54) SYSTEM AND METHOD FOR SELECTING AND DELIVERING CONTENT INTO MEDIA PLAYBACK APPLICATIONS

(75) Inventors: Gene R. COHEN, North Adams, MA (US); Laurence H. ZILL, North Adams, MA (US); Donald O. LECLAIRE, North Adams, MA (US); John F. ALBANO, North Adams, MA (US); Joseph S. MONTI, North Adams, MA (US); Nick BRANSTATOR, North Adams, MA (US)

Correspondence Address: NIXON PEABODY, LLP, 401 9TH STREET, NW, SUITE 900, WASHINGTON, DC, 20004-2128, US

(73) Assignee: VOODOO VOX, North Adams, MA (US)

(21) Appl. No.: 12/166,791

(22) Filed: Jul. 2, 2008

Related U.S. Application Data
(60) Provisional application No. 60/929,880, filed on Jul. 16, 2007.

(51) Int. Cl. H04M 3/42

(52) U.S. Cl. 379/201.02

(57) ABSTRACT

A system, method, and computer program product for selecting and delivering content to a telephony application includes receiving a request from a telephony service for interactive content, initiating a method call to a content selection system, and selecting a content item. Instructions for playing the selected content item are sent to the telephony service, and a content request for the selected content item is obtained based upon the instructions for playing the selected content item. The selected content item is then delivered to the telephony service. The system, method, and computer program product analyze characteristics of the request and of a user and deliver customized content based upon the characteristics. Interactivity between the user, the telephony service, and the system is provided.

### CROSS-REFERENCE TO RELATED APPLICATION

The present application claims the benefit of priority of U.S. Provisional Patent Application Ser. No. 60/929,880 entitled “SYSTEM AND METHOD FOR SELECTING AND DELIVERING CONTENT INTO A TELEPHONY APPLICATION” filed Jul. 16, 2007. The provisional application is incorporated by reference in its entirety.

### FIELD OF THE INVENTION

Embodiments of the present invention generally relate to delivering content to media playback systems and more particularly to selecting and delivering content into telephony applications.

### BACKGROUND OF THE INVENTION

Telephony applications can deliver a richer and more interesting experience to callers by integrating content from external sources. Examples of such applications include call center applications, unified messaging, voice mail, one-number applications, conference calling, on-hold, interactive voice response applications, and Voice Over IP systems. These applications may be hobbled by the lack of a system for selecting content appropriate to a given situation and delivering that content to the system for use in the application.

### SUMMARY OF THE INVENTION

Accordingly, in one aspect of the present invention, there is provided a method for selecting and delivering content to a telephony application, including receiving a request from a telephony service for interactive content, initiating a method call to a content selection system, selecting a content item from a content cache with the content selection system, sending instructions for playing the selected content item to the telephony service, obtaining a content request for the selected content item based upon the instructions for playing the selected content item, and delivering the selected content item to the telephony service.

Additionally, using a system and method of the present invention, content may be requested by and delivered to a system that plays audio other than a telephony system. For example, content may be requested by and delivered into a radio station's audio broadcast, an Internet audio stream, or a podcast. The choice of content selected by the content selection system may take the playback source into account and select appropriate content accordingly. The content providers may also offer certain content to be played only through certain playback systems, or offer multiple versions of the content, each appropriate to one or more playback systems. Examples of such content include advertising, offers, stock information, sports scores, traffic information, weather, news, and the like.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1A illustrates an exemplary system to request and deliver content to a telephony service system.

FIG. 1B illustrates an exemplary content selection system in accordance with the present invention.

FIG. 2A illustrates an exemplary method of requesting and delivering content to a telephony service system for playback and interaction.

FIG. 2B illustrates another exemplary method of requesting and delivering content to a telephony service system for playback and interaction.

FIG. 3 illustrates an alternative exemplary system to request and deliver content to a telephony service system, wherein calls may be transferred to the system for the duration of content playback and interaction.

FIG. 4 illustrates an exemplary network of content servers, such as the content server of FIG. 1, to deliver interactive content to telephony service systems.

FIG. 5 illustrates an exemplary structure of content servers, such as the content servers of FIG. 4.

FIG. 6 illustrates an exemplary call flow process.

FIG. 7 illustrates an exemplary method of creating and submitting new items of new content into a system, such as the system of FIG. 1.

FIG. 8 illustrates an exemplary system to select content appropriate for a telephone call for a telephony service provider.

FIG. 9 illustrates an exemplary method of selecting content appropriate for a telephone call for a telephony service.

### DETAILED DESCRIPTION OF THE INVENTION

Reference will now be made in detail to embodiments of the present invention. As used herein, the terms “a”, “an” and “the” may refer to one or more than one of an item. The terms “and” and “or” may be used in the conjunctive or disjunctive and will generally be understood to be equivalent to “and/or”.

There is a need for a method and system that addresses the above and other problems. The above and other problems are addressed by exemplary embodiments of the present invention, which provide for delivering interactive content to telephony systems and other media playback systems. Callers to the telephony systems may experience the content as an integral part of the system, but content providers (e.g., third-party content providers) may create the content separately from the telephony system itself. Additionally, content may be automatically selected on a per-call basis to provide a different and more appropriate interactive experience for each call. The content may be targeted to certain kinds of calls and/or callers, scheduled to run during a limited period of time, and limited to be served out a limited number of times.

For example, one of many possible advertisements might be selected for play on a certain call, based upon factors like its relevance to the caller, the time of day, the value of the advertisement, the number of times that advertisement is scheduled to be played in the next day, the number of calls expected to come in from a variety of telephony systems that are likely to be from callers with characteristics similar to the current caller, and so on.

Additionally, using a system and method of the present invention, content may be requested by and delivered to a system that plays audio other than a telephony system. For example, content may be requested by and delivered into a radio station's audio broadcast, an Internet audio stream, or a podcast. The choice of content selected by the content selection system may take the playback source into account and select appropriate content accordingly. The content providers may also offer certain content to be played only through certain playback systems, or offer multiple versions of the content, each appropriate to one or more playback systems. Examples of such content include advertising, offers, stock information, sports scores, traffic information, weather, news, and the like.

Contextual data related to the delivery of and interactions with served content may be made available to telephony system providers, content providers, and the owners of the system itself through Web-based interfaces and the like. This data may then be used by the system and method of the present invention to evaluate, select, and serve refined content to customize the delivered content, For example in a telephony environment, one of many possible advertisements might be selected for play on a certain call, based upon factors like its relevance to the caller, the time of day, the value of the advertisement, the number of times that advertisement is scheduled to be played in the next day, the number of calls expected to come in from a variety of telephony systems that are likely to be from callers with characteristics similar to the current caller, and so on.

Similarly in another audio delivery example, a radio station may have a scheduled opportunity in its audio broadcast to play content. Its automated scheduling and broadcast system then requests that content from the system, passing along contextual information. The content selection system then selects appropriate content for the radio broadcast, based upon that contextual information, information provided about each piece of content, and the fact that content is being selected for radio broadcast. It then passes back an appropriate item of content, which the radio station then plays on-air through its broadcast system.

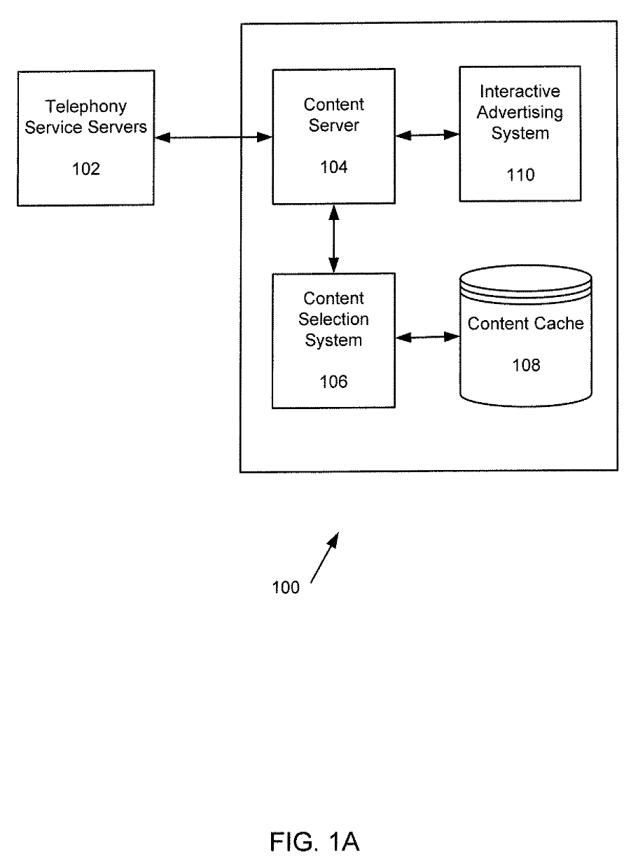

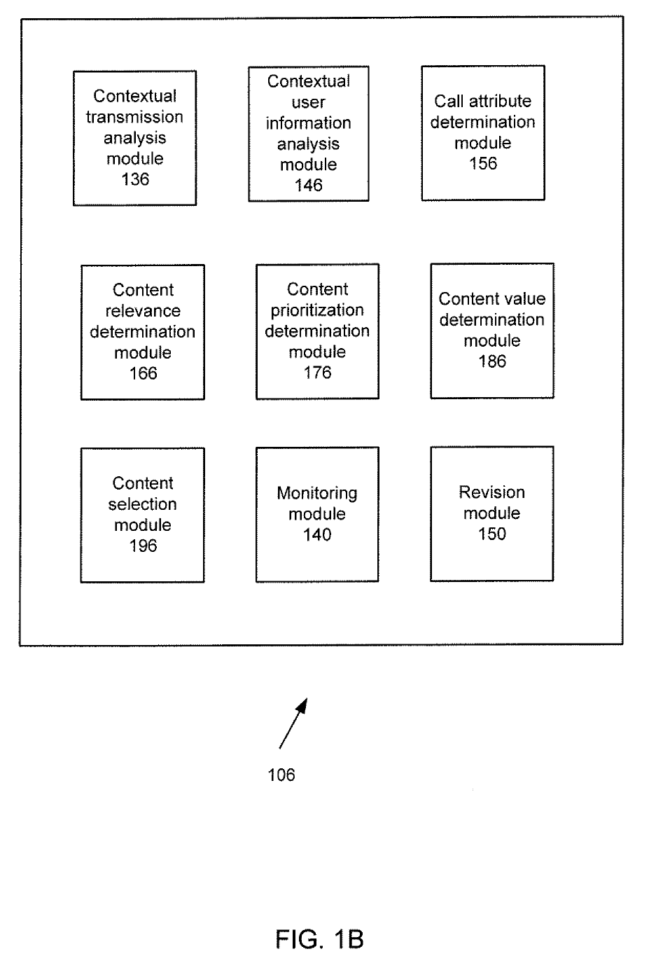

Referring now to the drawings, wherein like reference numerals designate identical or corresponding parts throughout the several views, and more particularly to FIG. 1A, there is illustrated an exemplary system 100 to request and deliver content to a telephony service system. The exemplary system 100 may include a content server 104 in communication with telephony service servers 102, a content selection system 106, and a content cache 108.

As shown further in FIG. 1B, the content selection system 106 may include a contextual transmission information analysis module 136 that analyzes contextual information regarding a telephone transmission to select the content item from the content cache, and a contextual user information analysis module 146 that analyzes contextual information regarding a user to select the content item from the content cache. The content selection system may also include a call attribute determination module 156, a content relevance determination module 166, a content prioritization determination module 176, a content value determination module 186, and a content selection module 196 that selects the content based on at least one of call attributes, content relevance, content prioritization, and content value. Of course other content selection mechanisms may also be used, including a content transmission order control module (not shown) where content is delivered in a particular order based upon user attributes or call attributes. Likewise, other content selection modules and delivery modules may be used based upon user and call attributes.

Further, the content selection system may also include a monitoring module 140 that monitors the request from the telephony service for interactive content, monitors the selected content item from the content selection system, monitors the content request for the selected content item, monitors the delivery of the selected content item to the telephony service, and monitors actions taken by a user interacting with the telephony service. The content selection system may further include a revision module 150 that revises the call attributes, the content relevance, the content prioritization, or the content value based upon monitored activity.

The content server 104 may be in communication with the content selection system 106, which may be in communication with the content cache 108. Content cache 108 may be any type of high speed data storage mechanism, including independent storage devices, sections of computer memory, and the like. The storage mechanisms may further include static RAM, dynamic RAM, internal (L1) caches, external (L2) caches, disk sectors, and the like. Likewise, servers 102,104 may be any suitable servers, workstations, PCs, laptop computers, PDAs, Internet appliances, handheld devices, cellular telephones, wireless devices, other devices, and the like, capable of performing the processes of the exemplary embodiments.

The exemplary system 100 may also include an interactive advertising system 110 that receives a transferred telephone transmission from the telephony system and accesses additional content items.

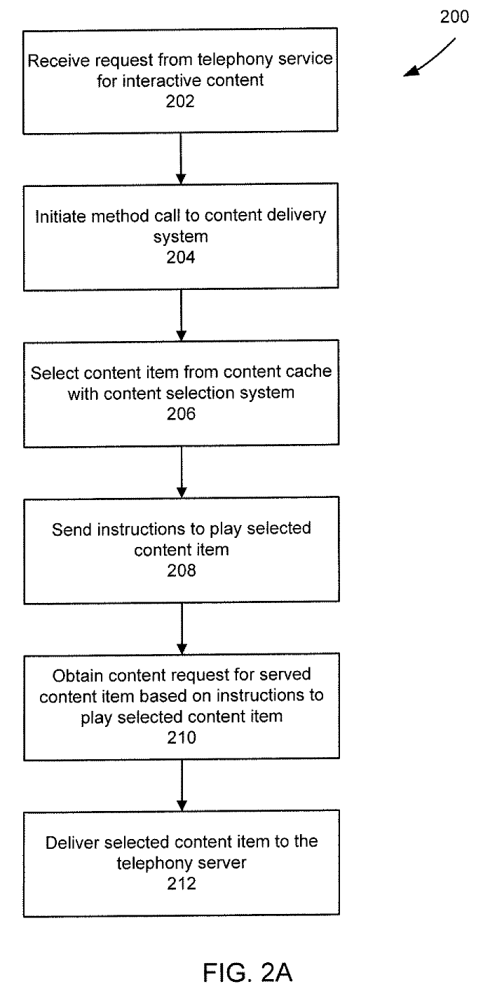

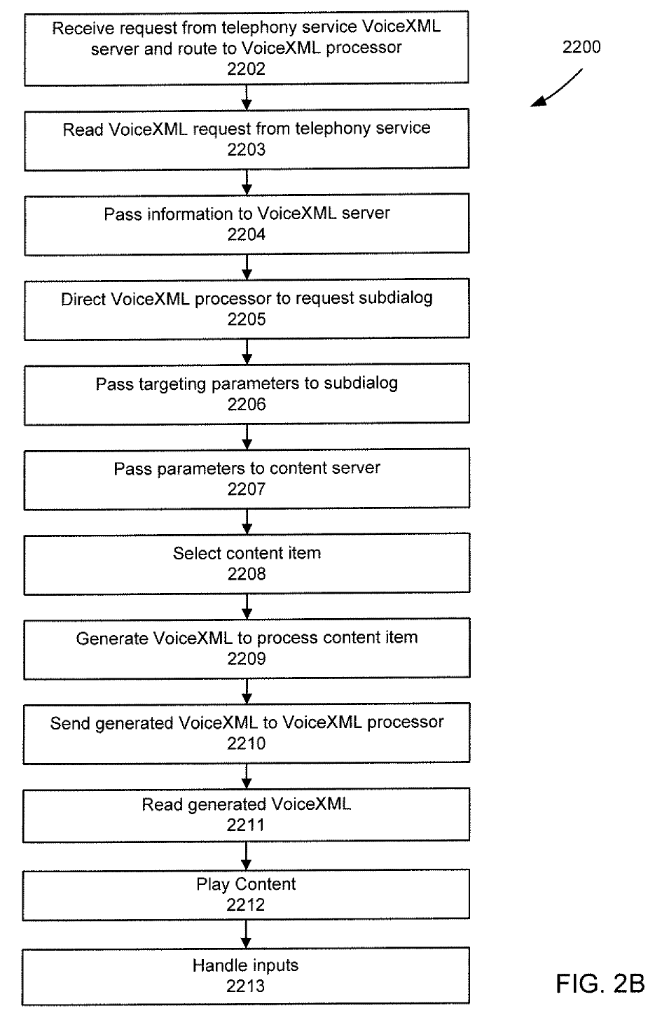

For ease of understanding and not by way of limitation, the operation of the exemplary system 100 is now described with reference to FIG. 2A, which illustrates an exemplary method 200 of requesting and delivering content to a telephony service system for playback and interaction. In operation 202, a call may reach a point where the telephony service wishes to play interactive content (e.g., display a text message, display a picture, display a video, display an advertisement, or play an audio message). The telephony service servers 102 may send a request to a pre-established content server 104. The request may be from a call, or alternatively, from a text message or other communication input. The request may contain contextual information about the call or caller (i.e., telephone transmission or user), such as the caller's preferred language, the location from which the caller initiated the call, the location to which the call was made, and the like.

In operation 204, the content server 104 makes a method call to the content selection system 106. In operation 206, the content selection system 106 selects an item of content (i.e., content item) from the content cache 108. Examples of the content items include audio items as well as text items, graphical advertisements, video items and the like. In operation 208, the selected content item may be returned to the content server 104, which may send instructions for content playback and interactivity to the telephony service servers 102. The instructions may also contain references to content hosted on the content server 104. For example, the references to content may be additional audio content, video content, multimedia content, instant messaging text, ringtone content, and the like that may be added and delivered as an additional content items to supplement the initial audio content item. In operation 210, the telephony service servers 102 interpret the instructions and request the content from the content server 104 as needed. In operation 212, the selected content item is delivered to the telephony service servers 102.

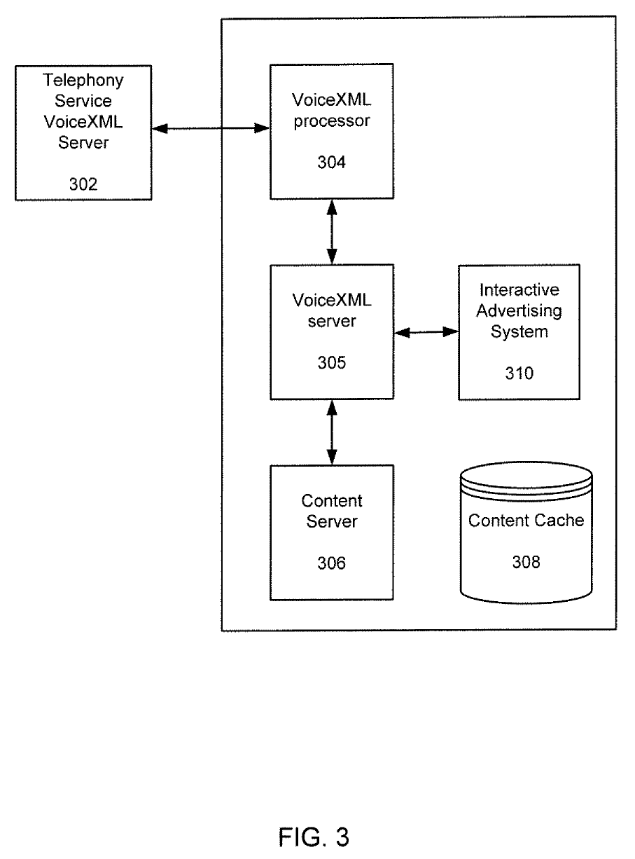

FIG. 3 illustrates another system 300 in accordance with the present invention that may be used to request and deliver content to a telephony service system where calls may be transferred to the telephony service system for the duration of content playback and interaction. The system 300 may include a markup language processor, such as a VoiceXML processor 304, in communication with a telephony service markup language processor, such as a VoiceXML server 302, a markup language server, such as a Voice XML server 305, a content selection system, such as a content server 306, and a content cache 308. The VoiceXML processor 304 may be in communication with the Voice XML server 305, which may be in communication with the content server 306, which may be in communication with the content cache 308. As before, content cache 108 may be any type of high speed data storage mechanism, including independent storage devices, sections of computer memory, and the like. The storage mechanisms may further include static RAM, dynamic RAM, internal (L1)) caches, external (L2) caches, disk sectors.

Likewise, servers 302, 305 may be any suitable servers, workstations, PCs, laptop computers, PDAs, Internet appliances, handheld devices, cellular telephones, wireless devices, other devices, and the like, capable of performing the processes of the exemplary embodiments.

The exemplary system 300 may also include an interactive advertising system 310 that receives a transferred telephone transmission from the telephony system and accesses additional content items.

For ease of understanding and not by way of limitation, the operation of the system 300 is now described with reference to FIG. 2A. In operation 2202, a call may be routed from the telephony service VoiceXML server 302 to the VoiceXML processor 304. The call routing may include a VoiceXML request. In step 2203, the VoiceXML processor may read VoiceXML from the telephony VoiceXML server 302, and in step 2204 pass information to the VoiceXML server 305 using standard HTTP query parameters.

In operation 2205, a VoiceXML instruction may direct the VoiceXML processor 304 to request a VoiceXML subdialog from the content server 306, and to pass targeting parameters to that subdialog in step 2206. In operation 2207, inside the subdialog, the parameters may be passed to the content server 306, which may select an appropriate item of content (e.g., an advertisement) from the content cache 308 in step 2208. Once the content server has selected an item of content, in step 2209 it may then generate the VoiceXML required to process that content. In operation 2210, the generated VoiceXML may be sent to the VoiceXML processor 304. In operation 2211, the VoiceXML processor 304 may read that generated VoiceXML and in step 2212 the VoiceXML processor may play the appropriate content (e.g., audio content) to the caller. In step 2213, the VoiceXML processor 304 handles any inputs (including lack of inputs or other user activities), which may be passed back to the VoiceXML server 305 so that subsequent VoiceXML pages may be generated and returned. When the content playback concludes, the subdialog may return, and the call may continue on the original telephony VoiceXML server 302.

For ease of understanding and not by way of limitation, another exemplary system in accordance with the present invention can request and deliver content to a telephony service system through Web services. The system may communicate with a Web services server via markup communicated over a protocol such as HTTP and the like. The Web services may request content from a content selection system and a content cache. The content selection system may respond with a content item that the Web services server then packages as a response to the telephony service system. The telephony service system may the play the returned content item.

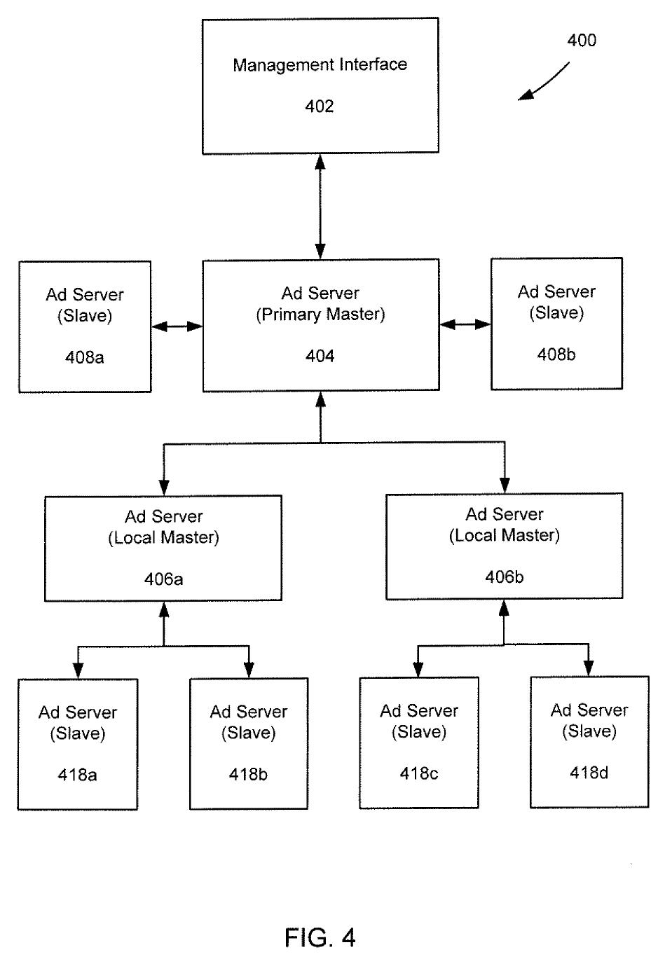

FIG. 4 illustrates an exemplary network 400 of such content servers, such as the content server 104 of FIG. 1, to deliver interactive content to telephony service systems. Network 400 may be controlled by a web-based management interface 402. Each content server may be responsible for serving content to telephony service system owners via a number of different connection types depending on the available protocols and platforms of the telephony system owner. The content servers may follow a master-slave relationship. A master, which may include a primary master 404 and local masters 406a, 406b may manage several automated tasks and may be a central point for statistics and reporting systems. Slaves 408a, 408b, 418a, 418b, 418c, 418d may be responsible for serving individual content requests and reporting statistics to a master 404, 406a, 406b.

There may be three types of content servers: primary master content servers 404, local master content servers 406, and slave content servers 408. For example, an entire In-Call Network Exchange (ICNX) system 400 may include one primary master content server 404, zero or more local master servers 406a, 406b, and zero or more slave content servers 408a, 408b, 418a, 418b, 418c, 418d. FIG. 4 outlines a basic structure of an ICNX content server system 400.

The primary master content server 404 may handle a number of different tasks, including controlling the timing of when contents may be inserted and removed from the active selection of content based on start and end time of content, and day and time targeting of content. The primary master content server 404 also manages the state of the content as may be controlled by the play and pause functions of the management interface 402 and reflected in active selection of content. Further, the primary master content server 404 receives in-memory caches of current content impression counts from slave content servers 408, 418. The primary master content server 404 may also stop the delivery of an item of content, and transition it to the ended state, when in-memory caches of current content impression counts reach target impression counts. Additionally, the primary master content server 404 receives and collates reporting summaries from slave content servers 408, 418 and manages performance, billing, and payment reports.

A local master content server 406 may perform a number of tasks as well, including receiving in-memory caches of current content impression counts from slave content servers 408, 418 and reporting them up to their master content server 404, 406. A local master content server 406 also receives and collates reporting summaries from slave content servers 408, 418 and reports them up to its master content server 406, 404.

A slave content server 408, 418 may handle a variety of tasks, including receiving and responding to content requests from publishers, tracking in-memory cache of current content impression counts and reporting them up to its master, and summarizing content events and reporting them up to its master content server.

Each content server, regardless of whether it is a primary master content server 404, local master content server 406, or slave server 408, 418 may fill the role of any other content server. The role of a server may be controlled by the software configuration and the database configuration. Each content server may include the necessary software and data to fill any type of role. This provides redundancy for the primary master content server 404. If the primary master server 404 becomes unavailable, the system and method of the present invention may provide a procedure for promoting a local master content server 406 or a slave content server 408, 418 to become the primary content server 404.

In addition, each content server may perform the tasks of a slave content server 408, 418 at any time regardless of the current role they perform. Finally, each content server may have one master content server with which it may communicate, though the primary master content server 404 may not have a master above it.

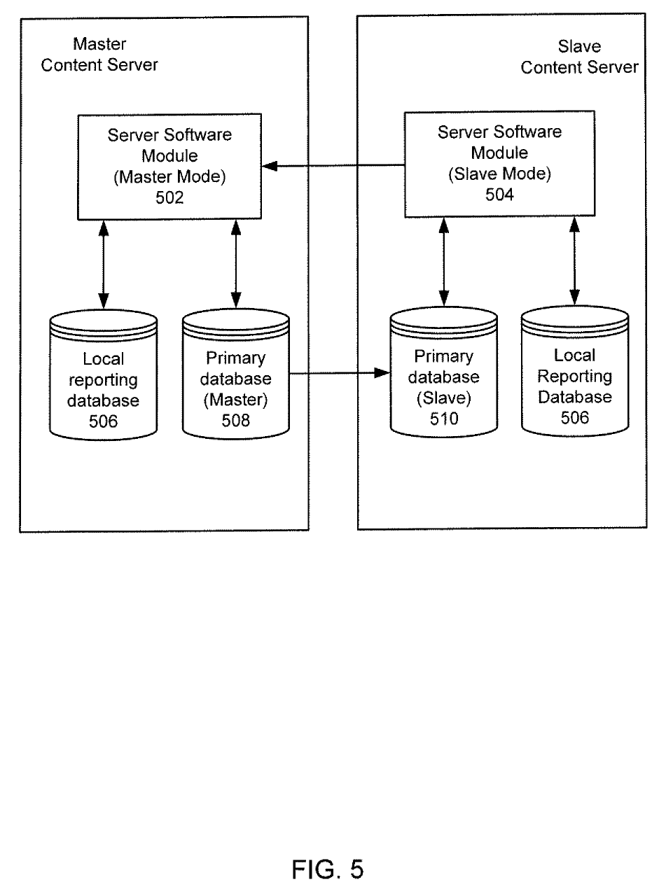

FIG. 5 illustrates an exemplary structure of content servers, such as the content servers 404, 406, 408, 418 of FIG. 4. The software 502, 504 may handle content requests, manage in-memory caches, and communicate with other content servers. The databases 506, 508, 510 may handle the storage and distribution of content-related data, master reporting summaries, and local reporting logs. The databases may be split into logical tasks. For example, one task may be represented by a primary database 508, which may be responsible for storing and retrieving content-related data and master reporting summaries. The primary database 508 may be writable by the primary master content server 404. As such, all operations which affect the primary database 508 may go through the primary master content server 404. Another task may be represented by a local reporting database 506, which may handle storing local events and summaries to be sent to its master.

There may be various primary types of data which may need to be distributed among content servers. These may include content-related data, reporting data, and impression data.

Content-related data may include data that defines items of content, content providers, and publishers. These data may be managed from the management interface 402, but some tasks may be performed by the primary master content server 404 on this data. This data may be mastered on the primary master database 508 and the distribution to local master content servers 406 and slave content servers 408 may be handled by the database itself via a replication system.

Reporting data may include all data associated with tracking content requests from publishers. The data may first be logged to the local reporting database 506 in a raw form. Processes in the slave content server 408 summarize this data to reduce reporting overhead and send this data to the slave content server's 408 master content server. Each intermediate local master content server may receive and collate the data, for example from multiple content servers, and send the collated data to its own master. Additionally, the primary master content server 404 may receive and collate this data in the primary master database 508 to be used by reporting, billing, and payment systems.

Impression data include the impression counts for items of content currently running or other data denoting numerical values or other analytics and metrics that may be used to determine the effectiveness of the items of content on the system. A purpose of this data may be to ensure that combined impression counts for content running on distributed content servers do not exceed the target impression count for the content that may be set by content providers. The target impression count may be set in the management interface 402 and may include an acceptable error range and criteria for counting impressions such as execution of code by a user's browser. This data may be stored in memory by slave content servers 408, or by master content servers performing slave operations, and transferred through local master content servers 406, to the primary master content server 404. After the primary master content server 404 receives this data, it may be written to the primary master database 508.

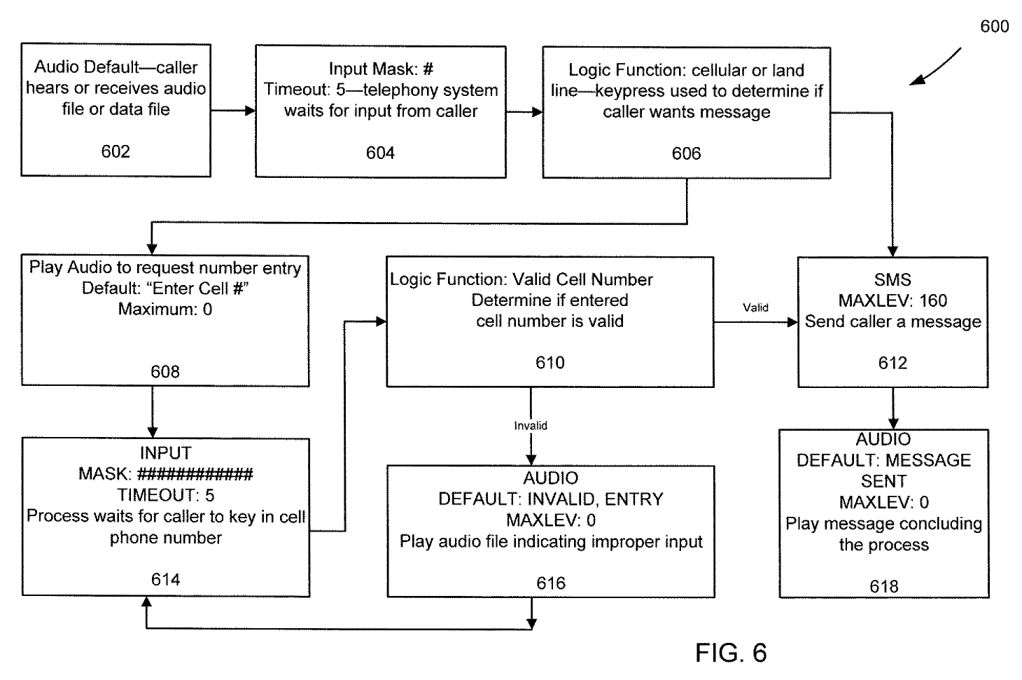

FIG. 6 illustrates an exemplary call flow 600. A call flow may describe structural elements of an item of content delivered by a content server, such as the content server 104 of FIG. 1, and the ways in which callers may interact with that content once it is served by a telephony service system. A call flow may be made up of one or more blocks. Each block may be a component of a call flow and include flow-level data and content-level data. Flow-level data may include data that may be generic to the flow and may be used across all content providers and items of content. Content-level data may include data that may be specific to the content implementing the flow and may be configurable by the content provider.

The example provided in FIG. 6 is of a “15 second text message” call flow 600. The call flow 600 describes an interaction with a caller wherein the caller listens to an audio file that may prompt him or her to press a number on a keypad of his or her phone or other telephony device, and then, depending on the number pressed, may be sent an SMS (Short Message Service) message or an MMS message (Multimedia Messaging Service), or a Mobile Instant Messaging, or the like. Of course, a similar call flow may occur when a user accesses a system in accordance with the present invention to make a cellular call, a long distance call, and the like. Further, the call flow may also describe a case where a user makes a call using a calling card, whereby the user picks up a phone, uses the calling card information to dial a desired phone number, enters a PIN or other identification number, and then hears a selected content item.

Returning to the example shown in FIG. 6, in operation 602, the caller may hear or receive a first audio file or other data file. In operation 604, the telephony system waits for a keypress from the caller. If; in operation 606, the keypress is determined to indicate that the caller wishes to receive a text message, a determination may be made as to whether the caller is calling from a cell phone. This determination may be made, for example, by checking a database of known cell phone numbers or by evaluating the signal received from the user's phone. If it is determined that the caller is not calling from a cell phone, the call flow 600 may proceed to operation 608 in which audio may be played asking the caller to enter a cell phone number. In operation 614, the call flow 600 waits for the caller to key in a phone number. In operation 610, a determination is made whether the entered number is a valid phone number. If the entered number is determined not to be a valid phone number, the call flow 600 proceeds to operation 616. In operation 616, an audio file indicating improper input is played, and the call flow 600 returns to operation 614 and waits for the input of a new number. If a determination is made that the entered number is proper, or during operation 606 it is determined that the caller is using a cell phone, the caller may be sent an SMS message or other message in operation 612. In operation 618, the caller may be played an audio message concluding the interaction.

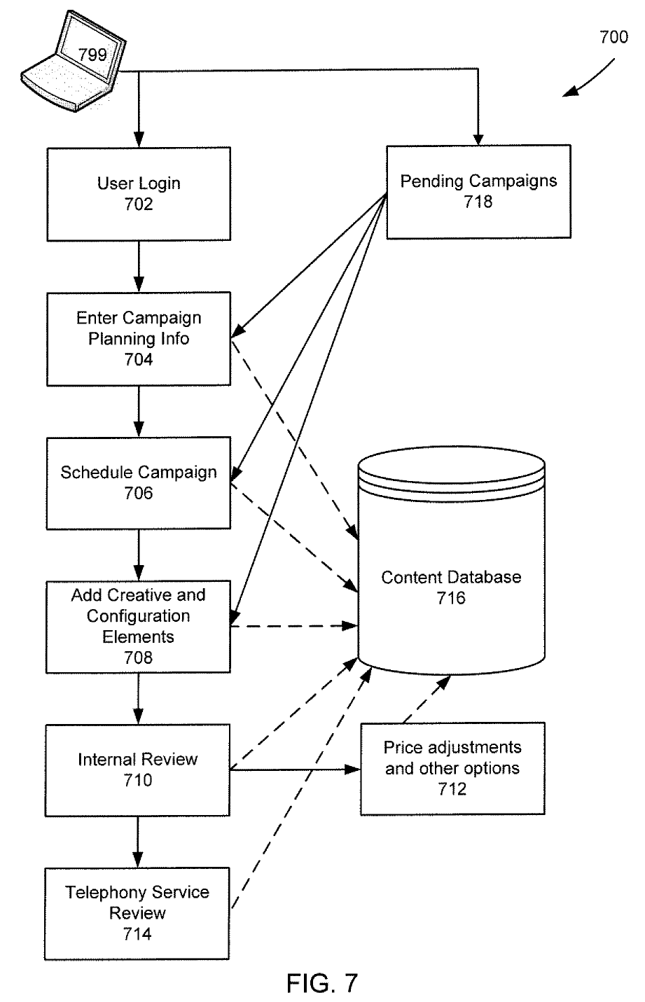

FIG. 7 illustrates an exemplary method 700 of creating and submitting items of new content into a system, such as the system 100 of FIG. 1. The items of new content may be entered by a content provider 799. The provider 799 may enter content through a Web-based system. In operation 702, a user from the provider 799 may login to the site. In operation 704, the user may begin by entering campaign planning information. A campaign may be a collection of one or more items of content with some shared characteristics. Planning may include choosing the structure and interactive elements of the content, choosing targeting information for the campaign and giving the campaign a name. Targeting information may include targeting callers by age or gender, targeting calls by time of day or day of week, and the like. In operation 706, the user may schedule the campaign. Scheduling may involve choosing a start and end date during which the content should be available, if there is to be a limit on applicable dates, and picking a target number of impressions, such as deliveries of the content, as well as indicating if there is to be a limit on the number of times the content is delivered.

In operation 708, the user may add creative and configuration elements to the campaign. These may include any audio, video, or graphic files that may be needed to complete the content that makes up the campaign, any SMS/email/instant messaging text, ringtone content, such as a pre-ring content item, a ring replacement content item, or a busy signal replacement content item that may be delivered, phone numbers to which callers may be transferred and the like. At the end of each operation of this method 700, entered data may be stored in a database 716, such as the content cache 108 of FIG. 1. In operation 718, through a web site, the user may access an interface that may list all pending campaigns, which is to say those campaigns for which the above operations may not have been completed. From this interface, the user may skip to the next operation that may need to be performed, edit, or change information that may have been provided in an earlier operation.

Once this information is provided, the user from the content provider 799 may be finished creating and submitting items of content into the system. In operation 710, the campaign may be reviewed by the system owners to verify that it is appropriate and well-formed. In operation 712, the system owners may configure pricing for the campaign, as well as other options, such as the prioritization of the campaign relative to other campaigns and reviewing the established campaign.

After review is complete, the information needed to determine which telephony service providers will play the content may be available, and these providers may, in operation 714, have the opportunity to review the campaign content as well. The telephony service providers may choose to accept or reject the content in the campaign. Any rejected content may not be served to that telephony service, while accepted content may be made available to be selected for play on that service. After a period of time, any un-reviewed content may be automatically accepted for play on the service, automatically rejected for play on the service, or otherwise acted upon by protocols determined by the providers.

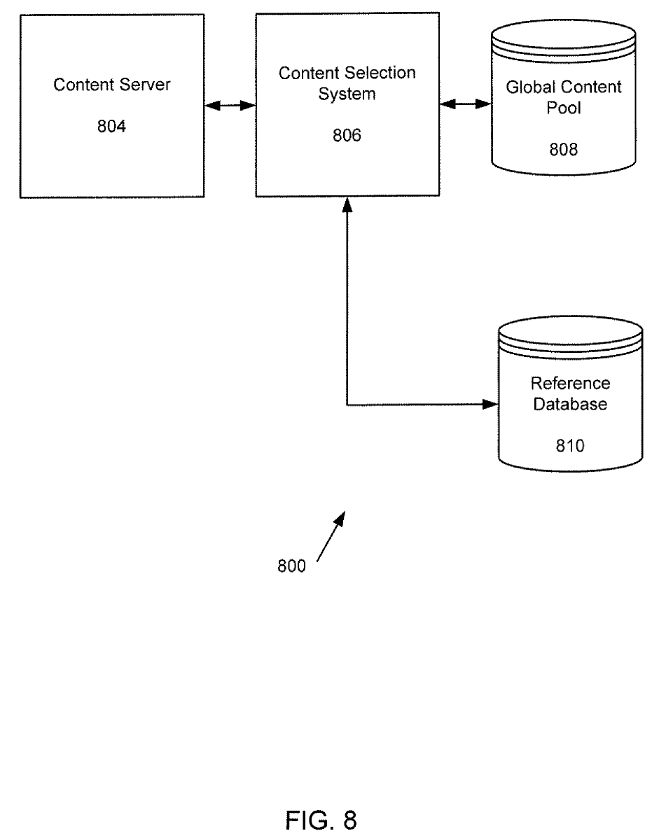

FIG. 8 illustrates an exemplary system 800 to select content appropriate for a telephone call for a telephony service provider. The system 800 may include a content server 804, such as the content server 104 of FIG. 1, a content selection system 806, such as the content selection system 106 of FIG. 1, a global content pool 808, such as the content cache 102 of FIG. 1, and a reference database 810. The content server 804 may be in communication with the content selection system 806, which may be in communication with the global content pool 808 and the reference database 810.

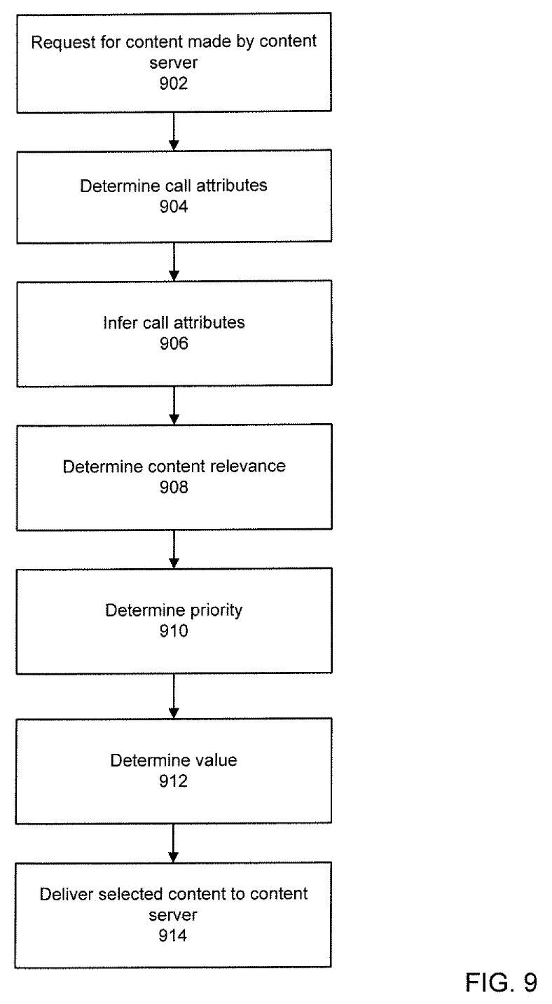

For ease of understanding and not by way of limitation, the operation of the system 800 is now described with reference to FIG. 9, which illustrates an exemplary method 900 of selecting content appropriate for a telephone call for a telephony service provider. Content that may be available to be delivered at any given time may be determined by a number of factors including whether the content, or its campaign, is active or paused, whether the content's start or end dates have been reached, whether the content is awaiting approval, whether the content has surpassed its impression target, and whether the content is scheduled to be available at a particular time of day or a particular day of the week. The content selection process may begin using the global content pool 808. In operation 902, a request for content may be made by the content server 804, which may in turn request content from the content selection system 806. In operation 904, the content selection system 806 may look at the global content pool 808 and determine attributes of the call, including contextual information about a telephone transmission or contextual information about a user. The attributes may include characteristics of the publisher the call originated from, the type of phone used (cellular vs. landline), wireless carrier if applicable, the time of day or day of week, caller ID, native language, age, gender, income, and location of the caller. Of course the call and caller may have other attributes that may also be determined and characterized by the system.

In operation 906, the selection process may utilize several reference tables in the reference database 810 to infer some of these attributes from others. For example, given a caller ID, the selection process may make a reasonable assumption as to whether the particular caller may fall into one or more income ranges. In operation 908, these attributes may be used in filtering to determine relevant content, That is, the selection process may be left with a smaller pool of content that may be more appropriate for the given caller. In operation 910, a notion of priority may be imposed. During the content-creation process, each item of content may be assigned a priority. Those priorities may be used at this point to filter the pool of possible content even further. In operation 912, a value of the content may be considered. Each item of content may include a value, which may include performance of the content item based on a calculable measure, and the dollar value of the cost of the content item.

In addition, the content selection process may also take into account prior telephone transmissions by the user, such as whether a particular piece of content has already been delivered to a caller during a call. If that is the case, that same content may not be delivered again. Further, the content selection process may also take into account a position for placement of the content item within a telephone transmission. Placement may be temporal such as content positioned to fit in a certain time frame or it may be physical such as a graphic ad placement on a user's cell phone screen. At this point, the selection process may have determined a final list of potential content that may be most relevant to serve for a particular caller. A single item of content may be chosen, for example, randomly from this list or according to some other pattern of delivery. In operation 914, the content selection system 806 may then deliver the selected content to the content server 804 that requested the content.

The content selection process may also monitor, record, examine, and characterize various actions performed by the telephony service, the user, or by the content selection system to revise one or more of the call attributes, the content relevance, the content prioritization, and the content value based on the scrutinized activity, The various actions may include monitoring the request from the telephony service for interactive content, recording the selected content item from the content selection system, examining the content request from the selected content item, characterizing the delivery of the selected content item to the telephony service, and evaluating actions taken by a user interacting with the telephony service.

Further, the performance of a selected content item may be reviewed. Performance may be characterized by one or more of revenue derived from the selected content item and a count of the number of times that the selected content item is delivered to the telephony service. The count of the number of times that the selected content item is delivered may be measured in a number of ways, including measuring the number of times a user selects a delivered hot link, such as an ad, on their cell phone, or by measuring the number of lines of text a user scrolls through on their cell phone. Of course other metrics and performance criteria may also be used to characterize performance of a selected content item.

The content selection process may further transfer a telephone transmission to an interactive advertising system to access additional items.

The above-described exemplary embodiments may be appropriate for a number of different contexts. Not by way of limitation, these contexts may include a calling card system, an on-hold system, and a Voice Over IP system. In the calling card context, a user may be presented with content while using a calling card. In the on-hold context, a user may be presented with content while on hold. In the Voice Over IP context, a user may be presented with content during the process of making a call.

For ease of understanding and to provide additional examples, and not by way of limitation, the above contexts are now described with reference to the exemplary system 100 of FIG. 1 and the exemplary method 200 of FIG. 2A. In the calling card context, a user (that is, a caller) may enter a calling card code into the telephony service servers 102. In the on-hold context, a user may be placed on hold. In the Voice Over IP context, a user may pick up their phone to make a phone call. In operation 202, the content server 104 may receive a request from the telephony service servers 102 for interactive content. The content server 104 may initiate a method call to the content selection system 106. In operation 206, the content selection system may select a content item from the content cache 108. In operation 208, instructions to play the selected content item, for example, relevant interactive news, weather, and sports reports, may be sent to the content server 104, which may send the instructions to the telephone service servers 102. In operation 210, the telephone service servers 102 may interpret the instructions and may request content from the content server 104 as needed. In operation 212, the selected content item may be delivered to the telephony service servers.

The above-described devices and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form such as voice, modem, and the like, wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for illustrative purposes, as many variations of the specific hardware used to implement the exemplary embodiments are possible, as will be appreciated by those skilled in the relevant arts. For example, the functionality of one or more of the devices and subsystems of the exemplary embodiments can be implemented via one or more programmed computer systems or devices.

To implement such variations as well as other modifications, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures such as records, tables, arrays, fields, graphs, trees, lists, and the like, included in one or more memories or storage devices. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical arts. Thus, the exemplary embodiments are not limited to any specific combination of hardware circuitry and/or software.

Stored on any one or on a combination of computer readable media, the exemplary embodiments of the present inventions can include software and instructions for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions with instructions recorded thereon for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that provides instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Thus, the exemplary embodiments include various novel features, for example, including a system for selecting and delivering content to a telephony application, to be delivered to the caller at some point during a call, where that content may include instructions for handling interactions with the caller, also to be interpreted and handled by the telephony application. Alternatively, the phone call may be transferred to the telephony application itself, which may take the selected content and play it for the caller, as well as handle any interactivity associated with the content. The telephony application can be a separate system on separate hardware with a separate owner from that of the claimed system. The telephony application may provide information to the system to allow for more targeted content selection. The telephony application may provide information about interactions of the caller with the content, for, among other uses, the purpose of tracking such interactions. There may be multiple telephony applications all requesting data from a single system. The content may be added to the system by a party other than the system owner. That content may be scheduled to only be available for a certain period of time, and may be indicated to require a certain number of deliveries to telephony applications over a period of time. That content may be targeted to only be delivered in certain circumstances, such as according to characteristics of the caller, the time of day or day of week, characteristics of the telephony application, prior user interaction, and so on. That content may be selected for delivery to a telephony provider based upon such targeting, as well as upon other prioritization considerations, such as stated requirements for the number of times a piece of content is delivered over a period of time, or a requirement that a set of content with shared characteristics may be delivered a certain number of times over a period of time. That content may include additional media and interactions outside the call itself such as SMS or email delivery, or transfer of the call to a different telephony system or phone number, where a content provider may be charged for the delivery of said content, and where the system may track money owed and create invoices, where a telephony provider may be paid for the playback of said content, and where the system may track money owed and create invoices, where content delivery is tracked by the system, and data is collected on its delivery, such as the number of times a piece of content has been delivered, or the number of times a user has selected an interaction with the content, where that data may be made accessible to the content provider, such as through a Web interface, where a telephony provider may review content that may be delivered to its system before that content can be played on that system, and reject content it deems inappropriate to its system, such as through a Web interface, and the like.

While the present inventions have been described in connection with a number of exemplary embodiments, and implementations, the present inventions are not so limited, but rather cover various modifications, and equivalent arrangements, which fall within the purview of prospective claims.

What is claimed is:

1. A computer-implemented method for selecting and delivering content to a telephony application, the method comprising:
receiving a request from a telephony service for interactive content;
initiating a method call to a content selection system;
accessing contextual information regarding at least one of the telephony service and a call into the telephony service;
matching the contextual information with a selection criterion provided by a content provider;
selecting a content item from a content storage device with the content selection system based upon the match of the contextual information and the selection criterion;
sending instructions for playing the selected content item to the telephony service;
obtaining a content request for the selected content item based upon the instructions for playing the selected content item; and
delivering the selected content item to the telephony service.

2. The method of claim 1, wherein accessing contextual information about at least one of the telephony service and a call into the telephony service includes:
accessing at least one of contextual information about a telephone transmission that is analyzed by the content selection system and used to select the content item from the content storage device, and contextual information about a user that is analyzed by the content selection system and used to select the content item from the content storage device.

3. The method of claim 2, wherein the selected content item comprises at least one of a pre-ring content item, a ring replacement content item, a busy signal replacement content item, a text message content item, a graphical content item, a video content item, and an electronic mail content item.

4. The method of claim 2 further comprising:
determining call attributes;
determining content relevance;
determining content prioritization;
determining content value; and
delivering the content based on at least one of call attributes, content relevance, content prioritization, and content value.

5. The method of claim 4 further comprising:
monitoring the request from the telephony service for interactive content;
monitoring the selected content item from the content selection system;
monitoring the content request for the selected content item;
monitoring the delivery of the selected content item to the telephony service;
monitoring actions taken by a user interacting with the telephony service; and
revising at least one of the call attributes, the content relevance, the content prioritization, and the content value based upon monitored activity.

6. The method of claim 5, wherein selecting the content item from the content storage device with the content selection system includes:
evaluating prior telephone transmissions by the user to the telephony service; and
selecting the content item based upon the evaluation of the prior telephone transmissions.

7. The method of claim 5, wherein selecting the content item from the content storage device with the content selection system includes:
selecting the content item based upon a position for placement of the content item within the telephone transmissions.

8. The method of claim 5 further comprising:
transferring the telephone transmission to an interactive advertising system to access additional content items.

9. The method of claim 5 further comprising:
delivering additional content based on actions taken by the user interacting with the telephony service.

10. The method of claim 5 further comprising:
reviewing performance of the selected content item, wherein performance is characterized by at least one of revenue derived from the selected content item and a count of number of times that the selected content item was delivered to the telephony service.

11. A system to select and deliver content to a telephony service comprising:
a content server that receives a request from a telephony service for interactive content and initiates a method call;
a content selection system that receives the method call from the content server and makes a selection of a content item;
a content storage device that receives the selection of a content item from the content selection system and delivers the selected content item to the content server;
wherein the content server, upon receipt of the selected content item, sends instructions for playing the selected content item to the telephony service and obtains a content request for the selected content item based upon the instructions for playing the selected content item, and delivers the selected content item to the telephony service.

12. The system of claim 11, wherein the content selection system includes at least one of a contextual transmission information analysis module that analyzes contextual information regarding a telephone transmission to select the content item from the content cache, and a contextual user information analysis module that analyzes contextual information regarding a user to select the content item from the content cache.

13. The system of claim 12, wherein the content selection system includes:
a call attribute determination module;
a content relevance determination module,
a content prioritization determination module,
a content value determination module; and
a content selection module that selects the content based on at least one of call attributes, content relevance, content prioritization, and content value.

14. The system of claim 13, wherein the content selection system includes:
a monitoring module that monitors the request from the telephony service for interactive content, monitors the selected content item from the content selection system, monitors the content request for the selected content item, monitors the delivery of the selected content item to the telephony service, monitors actions taken by a user interacting with the telephony service; and
a revision module that revises at least one of the call attributes, the content relevance, the content prioritization, and the content value based upon monitored activity.

15. The system of claim 14 further comprising:
an interactive advertising system that receives a transferred telephone transmission from the telephony system and accesses additional content items.

16. A computer program product with computer-executable instructions for selecting and delivering content to a telephony application comprising:
instructions for receiving a request from a telephony service for interactive content;
instructions for initiating a method call to a content selection system;
instructions for accessing contextual information regarding at least one of the telephony service and a call into the telephony service;
instructions for matching the contextual information with a selection criterion provided by a content provider;
instructions for selecting a content item from a content storage device with the content selection system based upon the match of the contextual information and the selection criterion;
instructions for sending instructions for playing the selected content item to the telephony service;
instructions for obtaining a content request for the selected content item based upon the instructions for playing the selected content item; and
instructions for delivering the selected content item to the telephony service.

17. The computer program product of claim 16, wherein the instructions for receiving the request from the telephony service includes accessing at least one of instructions for receiving contextual information about a telephone transmission that are analyzed by the content selection system and used to select the content item from the content storage device, and instructions for receiving contextual information about a user that are analyzed by the content selection system and used to select the content item from the content storage device.

18. The computer program product of claim 17, wherein the selected content item comprises at least one of a pre-ring content item, a ring replacement content item, a busy signal replacement content item, a text message content item, a graphical content item, a video content item, and an electronic mail content item.

19. The computer program product of claim 17, further comprising:
instructions for determining call attributes;
instructions for determining content relevance;
instructions for determining content prioritization;
instructions for determining content value; and
instructions for delivering the content based on at least one of call attributes, content relevance, content prioritization, and content value.

20. The computer program product of claim 19 further comprising:
instructions for monitoring the request from the telephony service for interactive content;
instructions for monitoring the selected content item from the content selection system;
instructions for monitoring the content request for the selected content item;
instructions for monitoring the delivery of the selected content item to the telephony service;
instructions for monitoring actions taken by a user interacting with the telephony service; and
instructions for revising at least one of the call attributes, the content relevance, the content prioritization, and the content value based upon monitored activity.

21. The computer program product of claim 20 further comprising:
instructions for transferring the telephone transmission from the telephony system to an interactive advertising system to access additional content items.

22. The system of claim 11, wherein the request from the telephony service for interactive content is a Voice XML request.

23. The system of claim 22 further comprising:
a VoiceXML processor that receives the VoiceXML request from the telephony service and passes query parameters based upon the VoiceXML request; and
a VoiceXML server that receives the query parameters from the VoiceXML processor and instructs the VoiceXML processor to request a VoiceXML subdialog from the content server and that further passes targeting parameters to the VoiceXML subdialog to be included in the method call.

24. The system of claim 23, wherein the selected content item sent by the content server includes VoiceXML instructions to process the selected content item.

25. The system of claim 24, wherein the VoiceXML instructions are read by the VoiceXML processor and played to the telephony service.

26. The system of claim 25, wherein the VoiceXML processor receives inputs from the telephony service and passes the inputs to the VoiceXML server, which generates a VoiceXML page and plays content request based upon the inputs from the telephony service.

27. The method of claim 5, wherein the request from the telephony service includes a Voice XML request.

28. The method of claim 27 further comprising:
receiving the VoiceXML request from the telephony service with a VoiceXML processor;
passing query parameters based upon the VoiceXML request to a VoiceXML server;
receiving the query parameters with the VoiceXML server;
instructing the VoiceXML processor to request a VoiceXML subdialog from the content server; and
passing targeting parameters to the VoiceXML subdialog to be included in the method call.

29. The method of claim 28, wherein the selected content item sent by the content server includes VoiceXML instructions to process the selected content item.

30. The method of claim 29 further comprising:
reading the VoiceXML instructions with the VoiceXML processor; and
playing the VoiceXML instructions to the telephony service.

31. The method of claim 30 further comprising:
receiving inputs from the telephony service with the VoiceXML processor;
passing the inputs to the VoiceXML server;
generating a VoiceXML page; and
playing a content request based upon the inputs from the telephony service.

32. The computer program product of claim 16, wherein the instructions for receiving the request from the telephony service includes instructions for receiving a Voice XML request.

33. The computer program product of claim 32 further comprising:
instructions for receiving the VoiceXML request from the telephony service with a VoiceXML processor;
instructions for passing query parameters based upon the VoiceXML request to a VoiceXML server;
instructions for receiving the query parameters with the VoiceXML server;
instructions for instructing the VoiceXML processor to request a VoiceXML subdialog from the content server; and
instructions for passing targeting parameters to the VoiceXML subdialog to be included in the method call.

34. The computer program product of claim 33, wherein the selected content item sent by the content server includes instructions for VoiceXML instructions to process the selected content item.

35. The computer program product of claim 34 further comprising:
instructions for reading the VoiceXML instructions with the VoiceXML processor; and
instructions for playing the VoiceXML instructions to the telephony service.

36. The computer program product of claim 35 further comprising:
instructions for receiving inputs from the telephony service with the VoiceXML processor;
instructions for passing the inputs to the VoiceXML server;
instructions for generating a VoiceXML page; and
instructions for playing a content request based upon the inputs from the telephony service.
